(19) United States
(12) Patent Application Publication
(10) Pub. No.: US 2014/0173134 A1
(43) Pub. Date: Jun. 19, 2014

(54) METHOD AND SYSTEM FOR OPTIMIZED OPPORTUNISTIC TRANSMISSION OF DOMAIN NAME REFERENCE INFORMATION

(71) Applicant: Hughes Network Systems, LLC, Germantown, MD (US)

(72) Inventors: George Choquette, Potomac, MD (US); Matthew Butehorn, Mount Airy, MD (US)

(73) Assignee: HUGHES NETWORK SYSTEMS, LLC, Germantown, MD (US)

(21) Appl. No.: 13/718,203

(22) Filed: Dec. 18, 2012

(51) Int. Cl. H04L 29/12

(52) U.S. Cl. CPC H04L 61/3025
USPC 709/245

(57) ABSTRACT

A system and method for efficiently and opportunistically delivering DNS reference information to a plurality of DNS proxies. A DNS proxy receives first DNS reference information associated with at least a first target hostname, wherein the first DNS reference information is based, at least in part, on a first DNS query of a further DNS proxy, other than the one DNS proxy. Further, the DNS proxy stores the first DNS reference information at a respective storage device.

### BACKGROUND

The overall capacities of broadband satellites are exponentially increasing, and such capacity increases present unique challenges in the associated ground system and network designs. The goal of the system designers, system operators, and service providers is to support and provide efficient, robust, reliable and flexible services, in a shared bandwidth network environment, utilizing such high capacity satellite systems. In current systems, for example, Domain Name System (DNS) provides a distributed and hierarchical naming system (e.g., domain names, hostnames, target names, etc.) for networked devices (e.g., computers, mobile devices, etc.), services (e.g., service providers) or any resource connected to the Internet or a private network. On networks utilizing DNS, the domain names may be associated with various standardized records and/or information items (e.g., Internet protocol (IP) address, geo-location, DNS proxy, etc.), where the domain names are converted/resolved, for example, to IP addresses so that users, applications, devices, and/or service providers may utilize a domain name to access/connect to a resource on a network identified by the domain name. For example, a user may utilize a domain name (e.g., web page) “www.exampletargetname.com” to connect to a resource available at the domain name without a need to know or use its associated IP address (e.g., 123.45.678.0). However, considering that a single web page may include a plurality of other embedded web pages/domain names and a steady rise in the number of users in a given network (e.g., increased network traffic), service providers experience increased traffic on their communication networks where delays in resolution of a domain name, and potentially other embedded domain names, can have a direct impact on quality of service and user experience in the networks. Accordingly, there is a need for an optimized network resource resolution and delivery mechanism.

### SOME EXEMPLARY EMBODIMENTS

The present invention advantageously addresses the needs above, as well as other needs, by providing a mechanism for an optimized resolution and delivery of DNS hostnames and information in a communication network by utilizing opportunistic transmissions of the DNS hostnames and information to a plurality of users based on various criteria associated, for example, with the DNS hostname and information, a plurality of users, network conditions, geo-locations of the users, and the like.

According to an exemplary embodiment, a method comprises receiving, by one or more Domain Name System (DNS) proxies, first DNS reference information associated with at least a first target hostname. The method also comprises storing, by a one of the DNS proxies, the first DNS reference information at a respective storage device, wherein the first DNS reference information is based, at least in part, on a first DNS query of a further DNS proxy, other than the one DNS proxy.

In another embodiment, the method comprises receiving, by the one DNS proxy, a DNS request for DNS reference information associated with at least a second target hostname, wherein the DNS request is received from at least one DNS client associated with the one DNS proxy. Additionally, the method comprises forwarding, to the at least one DNS client, the stored first DNS reference information associated with the first target hostname if the second target hostname relates to the first target hostname.

According to a further exemplary embodiment, the method comprises transmitting, by the one DNS proxy, a second DNS query for DNS reference information. Moreover, the method comprises receiving, in response to the second DNS query, second DNS reference information associated with at least the first target hostname. The method further comprises updating the first DNS reference information stored at the storage device based, at least in part, on one or more of the second DNS reference information, a retention timer, an age of the first DNS reference information, a time period since a last forwarding of the first DNS reference information to the at least one DNS client, and a retention weighting value.

In another exemplary embodiment, the method comprises receiving, by a Domain Name System (DNS) server, a first DNS query for resolving a first target hostname, wherein the first DNS query is received from a first DNS proxy. The method further comprises determining first DNS reference information associated with the first target hostname. Additionally, the method comprises transmitting, in response to the first DNS query, the first DNS reference information to the first DNS proxy and to one or more further DNS proxies.

According to another exemplary embodiment, the method comprises determining at least one characteristic associated with the first target hostname or the first DNS reference information, or a combination thereof, wherein the transmission of the first DNS reference information is based, at least in part, on the at least one characteristic.

In yet another exemplary embodiment, the method comprises receiving, by a one of the further DNS proxies, the first DNS reference information associated with the first target hostname. The method also comprises storing, by the one further DNS proxy, the first DNS reference information at a respective storage device.

According to an exemplary embodiment, the method comprises receiving, by the one further DNS proxy, a DNS request for DNS reference information associated with at least a second target hostname, wherein the DNS request is received from at least one DNS client associated with the one further DNS proxy. The method further comprises forwarding, to the at least one DNS client, the stored first DNS reference information associated with the first target hostname if the second target hostname relates to the first target hostname.

According to another exemplary embodiment, the method comprises transmitting, by the further DNS proxy, a second DNS query for DNS reference information. The method also comprises receiving, in response to the second DNS query, second DNS reference information associated with at least the first target hostname. Further, the method comprises updating the first DNS reference information stored at the storage device based, at least in part, on one or more of the second DNS reference information, a retention timer, an age of the first DNS reference information, a time period since a last forwarding of the first DNS reference information to the at least one DNS client, and a retention weighting value.

According to an exemplary embodiment, an apparatus comprises at least one processor, and at least one memory including computer program code for one or more programs, the at least one memory and the computer program code configured to, with the at least one processor, cause the apparatus to receive, by one or more Domain Name System (DNS) proxies, first DNS reference information associated with at least a first target hostname. The apparatus is also caused to store, by a one of the DNS proxies, the first DNS reference information at a respective storage device, wherein the first DNS reference information is based, at least in part, on a first DNS query of a further DNS proxy, other than the one DNS proxy.

In another embodiment, the apparatus is caused to receive, by the one DNS proxy, a DNS request for DNS reference information associated with at least a second target hostname, wherein the DNS request is received from at least one DNS client associated with the one DNS proxy. Additionally, the apparatus is also caused to forward, to the at least one DNS client, the stored first DNS reference information associated with the first target hostname if the second target hostname relates to the first target hostname.

According to a further exemplary embodiment, the apparatus is caused to transmit, by the one DNS proxy, a second DNS query for DNS reference information. Moreover, the apparatus is also caused to receive, in response to the second DNS query, second DNS reference information associated with at least the first target hostname. The apparatus is further caused to update the first DNS reference information stored at the storage device based, at least in part, on one or more of the second DNS reference information, a retention timer, an age of the first DNS reference information, a time period since a last forwarding of the first DNS reference information to the at least one DNS client, and a retention weighting value.

In another exemplary embodiment, the apparatus is also caused to receive, by a Domain Name System (DNS) server, a first DNS query for resolving a first target hostname, wherein the first DNS query is received from a first DNS proxy. The apparatus is further caused to determine first DNS reference information associated with the first target hostname. Additionally, the apparatus is caused to transmit, in response to the first DNS query, the first DNS reference information to the first DNS proxy and to one or more further DNS proxies.

According to another exemplary embodiment, the apparatus is caused to determine at least one characteristic associated with the first target hostname or the first DNS reference information, or a combination thereof, wherein the transmission of the first DNS reference information is based, at least in part, on the at least one characteristic.

In yet another exemplary embodiment, the apparatus is also caused to receive, by a one of the further DNS proxies, the first DNS reference information associated with the first target hostname. Also, the apparatus is caused to store, by the one further DNS proxy, the first DNS reference information at a respective storage device.

According to an exemplary embodiment, the apparatus is caused to receive, by the one further DNS proxy, a DNS request for DNS reference information associated with at least a second target hostname, wherein the DNS request is received from at least one DNS client associated with the one further DNS proxy. Additionally, the apparatus is also caused to forward, to the at least one DNS client, the stored first DNS reference information associated with the first target hostname if the second target hostname relates to the first target hostname.

According to another exemplary embodiment, the apparatus is also caused to transmit, by the further DNS proxy, a second DNS query for DNS reference information. Moreover, the apparatus is caused to receive, in response to the second DNS query, second DNS reference information associated with at least the first target hostname. Further, the apparatus is caused to update the first DNS reference information stored at the storage device based, at least in part, on one or more of the second DNS reference information, a retention timer, an age of the first DNS reference information, a time period since a last forwarding of the first DNS reference information to the at least one DNS client, and a retention weighting value.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B and 1C illustrate communications systems capable of employing an approach for optimized domain name resolution and delivery system, in accordance with various exemplary embodiments;

FIG. 2 illustrates an optimized domain name resolution and delivery system, according to an exemplary embodiment of the present invention;

FIG. 3 depicts a flow chart illustrating an optimized domain name resolution and delivery process, in accordance with various exemplary embodiments;

FIGS. 4A and 4B depict flow charts illustrating various processes for, at least, determining domain name resolution and characteristics information, in accordance with various exemplary embodiments;

FIG. 5 depicts a flow chart illustrating an optimized domain name resolution and delivery process, in accordance with various exemplary embodiments;

FIG. 6 illustrates a computer system upon which exemplary embodiments according to the present invention can be implemented; and

FIG. 7 illustrates a chip set in which exemplary embodiments of the present invention may be implemented.

### DETAILED DESCRIPTION

Examples of a method, apparatus, and computer program for optimized resolution and transmission of a DNS target hostname and associated information in a network are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

It is noted that the terms “target hostname,” “web page,” and “domain name” may be used interchangeably, according to some embodiments of the present invention, wherein certain communication network information (e.g., IP address, geo-location, DNS proxy, etc.) may be associated with said terms.

As mentioned, the DNS is a hierarchical naming system standardized by the Internet Engineering Task Force (IETF) that, among other things, allows users and user devices (e.g., applications on computers, smartphones, tablets, etc.) to identify Internet hosts using a mnemonic domain name rather than an IP address. Use of domain names simplify web browsing as users and programmers may more easily remember and enter the mnemonic domain name than the IP address numeric sequence, wherein the domain name owners/providers may change a host IP address without needing to notify users and applications of the change. For example, a web browsing application may transparently use the domain name resolution service of a DNS resolver within a user device, which in turn may contact an available DNS server to request for the host IP address for a given domain name. For example, “www.facebook.com” may be utilized to identify a Facebook® host, rather than “ddd.ddd.ddd.ddd” (e.g., type “A” DNS request) for a host IP version four (IPv4) address, or “xxxx.xxxx.xxxx.xxxx.xxxx.xxxx.xxxx.xxxx” (e.g., type “AAAA” DNS request) for a host IPv6 address. Another record type of interest is an alias resource record type, sometimes designated as type “CNAME.” The domain name aliases permit naming indirection, in which a first domain name (the alias) resource record points to a second domain name resource record, and so on, until the final domain name resource record is reached, which may be pointing to the host IP address. A DNS server that supports recursive DNS queries may return, in a DNS response, a chain of resource records from the requested (alias) domain name to the final domain name and host IP address. A DNS server that may not support recursive DNS queries may return only the top (alias) record pointing to a next domain name, and the DNS client may have to follow the chain by making successive requests. Some network (e.g., satellite) systems optimize web browsing response time by parsing to identify embedded domain names and objects of a requested top level web page to be sent by a satellite gateway (GW), prefetching and sending those embedded domain name resolutions and objects to be cached in the user satellite terminal (user terminal), and supplying those domain name resolutions and objects from cache as they are requested by the user web browser. The response time is optimized because the inroute satellite hop latency (e.g., in the direction from a user terminal to the satellite gateway) to request resolution of a domain name or to request embedded webpage objects is omitted, and because outroute responses (e.g., in the direction from the satellite gateway to the user terminal) can be sent before they are requested by the browser. However, this acceleration technique may not be effective for secure web browsing/transactions (e.g. financial, personal, company, proprietary, etc.) for example via HTTPS, because the top level page is encrypted and may not be parsed at the GW to facilitate domain name resolution prefetching and object prefetching. Therefore, there is a need for an efficient and optimized DNS resolution services for minimizing delay in the services and distribution of associated information to users in a communication network where content and network resources may be accessed via secure and/or non-secure web pages.

In accordance with exemplary embodiments of the present invention, a DNS system (e.g., a GW in a network) may opportunistically broadcast or multicast DNS resolution and the associated information to a plurality of users in order to accelerate delivery of the information for utilization by the users, for example, for accessing secure and non-secure resources associated with various web pages. In various embodiments, a DNS resolution system may deliver the DNS resolution information, for example to wireless terminals, via broadcast or multicast transmission messages whereby the terminals may store (e.g., cache) and/or utilize the information when attempting to access (e.g., browse) various web pages.

Various embodiments of the present invention take advantage of broadcast or multicast capabilities of a network (e.g., wireless, wired, etc.) to opportunistically accelerate DNS resolution and therefore accelerate secure and non-secure browsing and other user applications. In one embodiment, requested DNS resolution information may be broadcast or multicast to a user terminal where the resolution information may be stored (e.g., cached), utilized, forwarded, etc. In this manner, the requesting user terminal may receive the desired DNS resolution information and provide it to a requesting client application (e.g., a web browsing application on a smart phone, or on a personal computer in communication with the user terminal). In one embodiment, one or more other user terminals with connectivity to the DNS system, for example in the same radio coverage region receiving the broadcast or multicast DNS resolution information, may receive and store (e.g., cache) the DNS resolution information in anticipation that one or more client applications that the user terminal serves may request one or more portions of the same DNS resolution information just received. For instance, in a multiuser environment, it is possible that only a first user, within a given service coverage area and retention time domain, requesting DNS resolution services for a specific target hostname may be delayed by the round trip request/response time associated with the a GW and/or a DNS server. Further, other users subsequently requesting DNS resolution for the same specific target hostname may benefit from elimination of one or many underlying round trips, the round trip for the top level domain name for a page, and those for domain names embedded within the page, wherein cache entry retention times for those domain name entries may have not expired yet. Furthermore, users visiting other web sites that embed common domain names may also benefit from reduced round trips. Opportunistically cached domain name resolutions may also benefit non-secure browsing performance, whether or not other web acceleration techniques are applied. These advantages may be realized without use of additional outroute bandwidth, and without administrative overhead to configure and maintain a DNS cache. Additionally, opportunistic domain name resolution caching may be beneficial for access (e.g., wireless) to enterprise Intranets in addition to benefiting access to the Internet.

In general, a substantial number of Internet users in a given region may visit same web pages in a given day, for example Facebook®, YouTube®, Google®, and the like, where each web may further include a plurality of other target hostnames, wherein utilization of the present invention may allow a substantial number of users to benefit from caching associated DNS resolution information at user terminals with minimal or no additional tasks performed by the network operator. A web browser, a platform DNS resolver and/or other client applications may maintain a cache of domain name resolutions where retention duration of an application cache entry may be governed by a “time-to-live” (TTL) parameter indicated in a DNS response, may be adjusted according to application or platform policy, and the like. In some instances, domain name owners/providers set the TTL to be a short time in order to facilitate load distribution across multiple hosts with different IP addresses and/or to allow for domains to be moved from one host to another host. In some instances, a short TTL parameter may have minimal impact on user perceived response time where the same domain name may be required again, for example, where the latency between the client and the DNS server is very small (e.g., for terrestrial wireline access to the Internet.) Further, some client application caches also apply a floor value (i.e., to raise TTL to be no less than a particular value) to reduce loading on the platform DNS resolver. However, the time elapsed to resolve domain names may have a noticeable impact on web browsing response time for some wireless systems having higher latency, and response time may be improved if domain name resolution can be optimized. For example, in a wireless system that uses a satellite in geosynchronous orbit, a round-trip time, from application request to a response, for signal propagation and related interactions among components of the system may be around one second, where user perceived response time to see a requested web page may therefore include several seconds for DNS resolution of a web page referencing several different domain names.

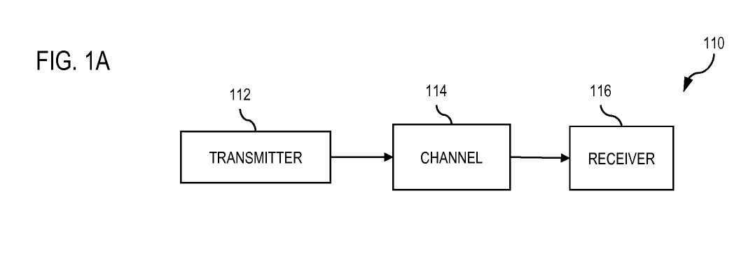

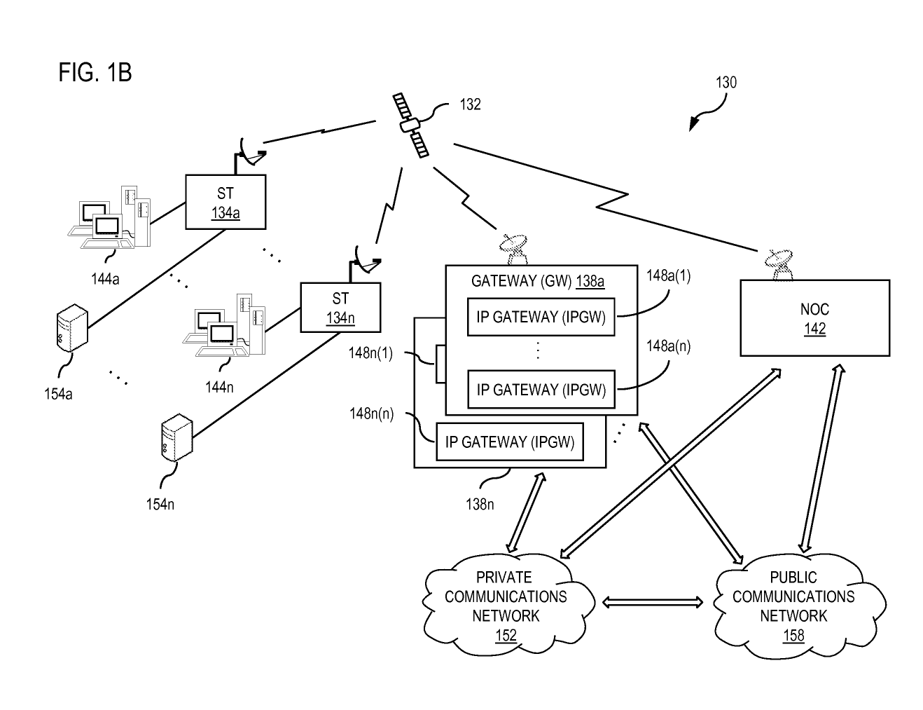

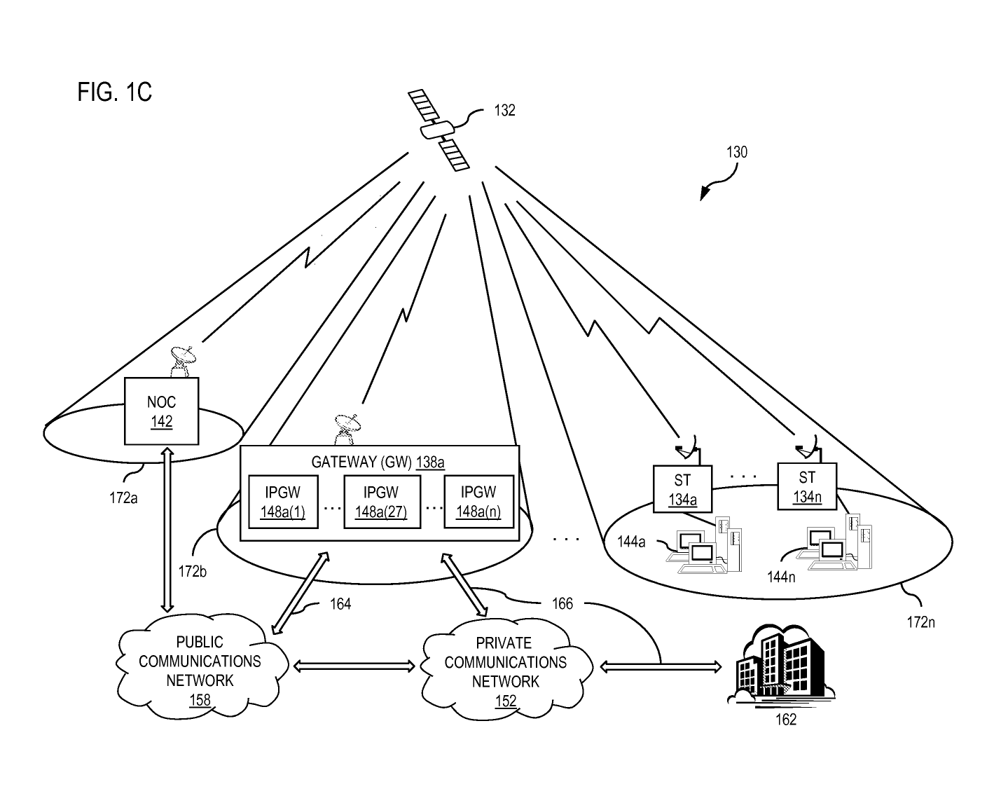

FIGS. 1A-1C illustrate communications systems capable of employing an approach for optimized domain name resolution, according to exemplary embodiments of the present invention. With reference to FIG. 1A, a digital communications system 110 includes one or more transmitters 112 (of which one is shown) that generate signal waveforms across a communication channel 114 to one or more receivers 116 (of which one is shown). In this discrete communications system 110, the transmitter 112 has a signal source that produces a discrete set of data signals, where each of the data signals has a corresponding signal waveform. These signal waveforms are attenuated, or otherwise altered, by communications channel 114. Coding may be utilized to combat noise and other issues associated with the channel 114, such as forward error correction (FEC) codes.

FIG. 1B illustrates an exemplary satellite communications system 130 capable of supporting communication among terminals with varied capabilities, according to exemplary embodiments of the present invention. The satellite communications system 130 (also referred to as system 130) includes a satellite 132 that supports communication among multiple satellite terminals (STs) 134a-134n, a number of gateways (GWs) 138a-138n, and a network operations center (NOC) 142. The NOC 142 performs the management plane functions of the system 130, while the GWs 138a-138n perform the data plane functions of the system 130. For example, the NOC 142 performs such functions as network management and configuration, software downloads (e.g., to the STs 134a-134n), status monitoring, statistics functions (e.g., collection, aggregation and reporting), security functions (e.g., key generation, management and distribution), ST registration and authentication, and GW diversity management. The NOC 142 communicates with each GW via the satellite 132, or via a secure private communications network 152 (e.g., an IPsec tunnel over a dedicated link or a virtual private network (VPN) or IPsec tunnel through a public network, such as the Internet). Additionally, each GW and the NOC have connectivity to one or more public communications networks 158, such as the Internet or a PSTN.

According to a further exemplary embodiment, each of the GWs 138a-138n include one or more gateways (IPGWs)—whereby the data plane functions are divided between a GW and its respective IPGWs. For example, GW 138a includes IPGWs 148a(1)-148a(n) and GW 138n includes IPGWs 148n(1)-148n(n). A GW may perform such functions as link layer and physical layer outroute coding and modulation (e.g., DVB-S2 adaptive coding and modulation), link layer and physical layer inroute handling (e.g., IPOS), inroute bandwidth allocation and load balancing, outroute prioritization, web acceleration and HTTP compression, flow control, encryption, redundancy switchovers, and traffic restriction policy enforcement. Whereas, the IPGW may perform such functions as data compression, TCP performance enhancements (e.g., TCP performance enhancing proxies, such as TCP spoofing), quality of service functions (e.g., classification, prioritization, differentiation, random early detection (RED), TCP/UDP flow control), bandwidth usage policing, dynamic load balancing, and routing. Further, a GW and respective IPGW may be collocated with the NOC 142. The STs 134a-134n provide connectivity to one or more hosts 144a-144n and/or routers 154a-154n, respectively. The system 130 may operate as a bent-pipe system, where the satellite essentially operates as a repeater or bent pipe. Alternatively, the system 130 may employ a switching or processing satellite supporting mesh communications (point-to-point communications directly between, for example, the two STs 134a and 134n).

In a system 130 that employs a processing satellite (e.g., including a packet switch operating, for example, at a data link layer), the system may support direct unicast (point-to-point) communications and multicast communications among the STs 134a-134n and GWs 138a-138n. In the case of a processing satellite, the satellite 132 decodes the received signal and determines the destination ST or STs and/or GWs. The satellite 132 then addresses the data accordingly, encodes and modulates it, and transmits the modulated signal to the destination ST or STs (e.g., ST 134n) and/or GWs (and their respective IPGWs). According to exemplary embodiments, the system 130 thereby provides a fully meshed architecture, whereby the STs 134a-134n directly communicate, via a single hop, over the satellite 132.

In a bent-pipe system of an exemplary embodiment, the satellite 132 operates as a repeater or bent pipe, and communications to and from the STs 134a-134n are transmitted over the satellite 132 to and from respective IPGWs associated with particular STs. Further, in a spot beam system, any one spot beam (e.g., beams 172a-172n—See FIG. 1C) operates as a bent-pipe to geographic region covered by the beam. For example, each spot beam operates as a bent pipe communications channel to and from the STs and/or IPGW(s) within the geographic region covered by the beam. According to one embodiment, several GWs/IPGWs are distributed across the geographic region covered by all spot beams of the satellite 132, where, in a beam in which a GW (and respective IPGWs) are located, only the one GW (and no STs) occupies that beam. Further, each IPGW may serve as an aggregation node for a multitude of remote nodes or STs. The total number of GWs/IPGWs, and the geographic distribution of the GWs/IPGWs, depends on a number of factors, such as the total capacity of the satellite dedicated to data traffic, geographic traffic loading of the system (e.g., based on population densities and the geographic distribution of the STs), locations of available terrestrial data centers (e.g., terrestrial data trunks for access to public and private dedicated networks).

More specifically, with reference to FIG. 1C, for example, for a data communication from ST 134a to a public communications network 158 (e.g., the Internet), the ST 134a is associated with an IPGW (e.g., IPGW 148a(1)—selected from a pool of IPGWs available to the ST 134a, such as IPGWs 148a(1)-148a(27)—where the pool of IPGWs is a suitable subset of the IPGWs 148a(1)-148a(n) located at the GW 138a). The data is first transmitted, via the satellite 132, from the ST 134a to associated IPGW 148a(1). The IPGW 148a(1) determines the destination as being the Internet 158. The IPGW then repackages the data (e.g., as a TCP/IP communication), and routes the data communication, via the terrestrial link 164, to the Internet 158. Further, in a corporate network, for example, a corporation may deploy various remote STs at remote offices. More specifically, ST 134n, located at a remote corporate location, may desire to securely communicate with the corporate headquarters 162. Accordingly, for a data communication from ST 134n to the corporate headquarters 162, the data is first transmitted, via the satellite 132, from the ST 134n to an IPGW associated with the ST 134n (e.g., IPGW 148a(27)). The IPGW 148a(27) determines the destination as being the corporate headquarters 162. The IPGW then repackages the data (e.g., as an IPsec communication), and routes the IPsec data communication, via the secure terrestrial links 166 (over the private communications network 152), to the corporate headquarters 162. In the corporate network scenario, a further example involves a corporate communication from the corporate headquarters to a number of remote sites (e.g., a multicast communication to STs 134a-134n)—where STs 134a-134n are correspondingly associated with the two IPGWs 148a(1) and 148a(27) (e.g., grouped between the two IPGWs based on load balancing and IPGW capabilities). In this scenario, a gateway or router, within the local network of corporate headquarters 162, transmits the data communication, via the secure terrestrial links 166 (over the private communications network 152), to the IPGWs 148a(1) and 148a(27). The IPGWs determine that the communication is destined for the remote STs 134a-134n, and package the data as a multicast communication addressed to the community of STs 134a-134n. The IPGWs then transmit the data communication, via the satellite 132, for decoding by the community of STs 134a-134n. Accordingly, the satellite of such a system acts as a bent pipe or repeater, transmitting communications between the STs 134a-134n and their respective associated IPGWs 148a-148n.

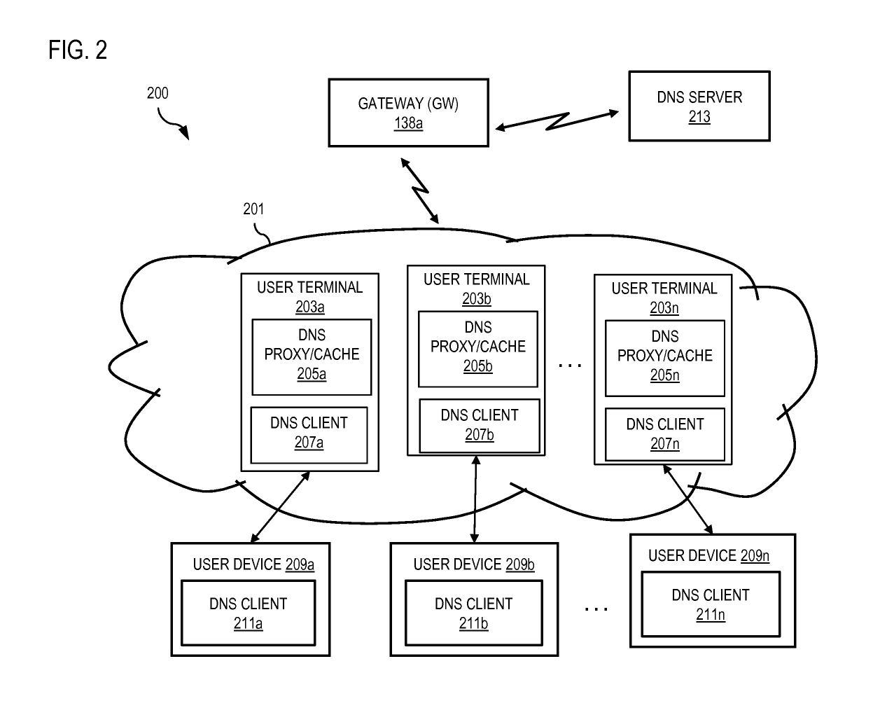

FIG. 2 illustrates an optimized domain name resolution and delivery system, according to an exemplary embodiment of the present invention. In one embodiment, the system 200 includes communication network 201 which may provide wired and/or wireless communication access to one or more user terminals 203a-203n (also collectively referred to as UT 203 or UTs 203) and/or one or more user devices. Each UT 203 may include a DNS proxy 205a-205n (also collectively referred to as DNS proxy 205 or DNS proxies 205), and a DNS client 207a-207n (also collectively referred to as DNS client 207 or DNS clients 207). Further, each UT 203 may provide one or more services to one or more user devices 209a-209n (also collectively referred to as UD 209 or UDs 209), wherein each UD 209 may include a DNS client 211a-211n (also collectively referred to as DNS client 211 or DNS clients 211), and one or more applications and modules for performing various tasks, for example, web browsing, a map application, a multimedia application, and the like. In one embodiment, a UT 203 partially or completely may be implemented in a UD 209. DNS resolution services are required by DNS client applications 105 and 106 running on the end user devices, 103 and 105 respectively, and/or DNS client applications 207 and 208 running on the user terminals, 203 and 204 respectively. A DNS client is a component/module that generates requests/queries for resolving the domain names via a DNS server and then caches the DNS resolution information, records, and/or references. Further, a DNS proxy is a software application in an intermediary device that receives the DNS queries from a DNS client, forwards the queries to the DNS server, receives and caches the response, and forwards that response to the DNS client on a requesting host (e.g., a user device). Furthermore, a DNS resolver is any local agent that receives a DNS request and retrieves information associated with the domain name in the DNS request. The client-side of the DNS, such as a DNS client or a DNS proxy, or any application such as a web browser that supports DNS lookup and caching, are considered as DNS resolvers. In one embodiment, DNS resolution services may be provided by a DNS server 213, which may be accessible via the GW 138 for providing broadcast, multicast, and/or unicast messages, for example, to one or more UTs 203 and/or UDs 209 where the GW 138 may or may not provide access to the Internet or Intranet services.

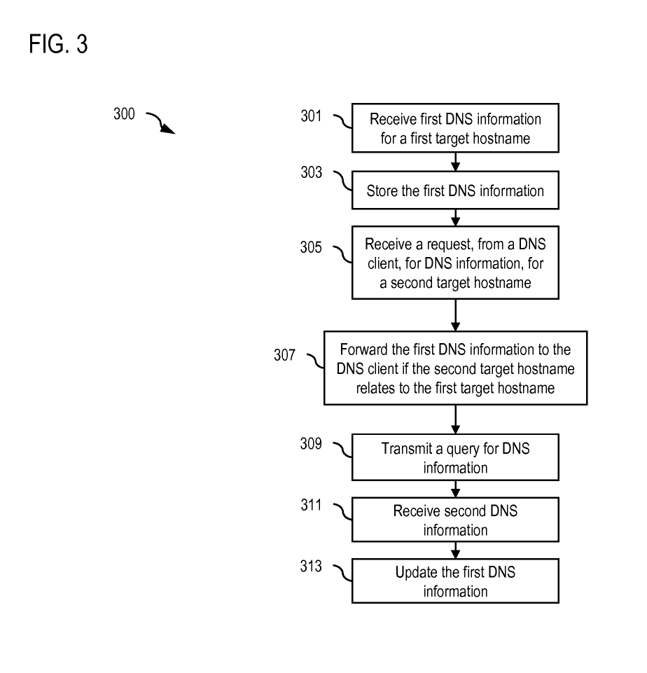

FIG. 3 depicts a flow chart illustrating an optimized domain name resolution and delivery process, in accordance with various exemplary embodiments.

Process 300 begins at step 301, where one or more DNS proxies 205 receive first DNS reference information associated with at least a first target hostname. In one instance, there may be a plurality of DNS proxies 205, for example in UTs 203 and/or UDs 209, where one or more of the DNS proxies 205 may receive, from the GW 138 and/or the DNS 213 server, DNS resolution reference information associated with one or more target hostnames. Further, according to an exemplary embodiment, the first DNS reference information is received by at least one of the DNS proxies 205 (e.g., DNS proxy 205a of UT 203a), where the first DNS reference information was sent (e.g., via a broadcast or a multicast transmission) in response to a first DNS query of a DNS proxy other than the receiving DNS proxy 205a). In other words, the one DNS proxy (e.g., DNS proxy 205a) receives the first DNS reference information despite the fact that the information was requested by a different DNS proxy (e.g., DNS proxy 205b of the UT 203b). In various embodiments, the plurality of the DNS proxies 205 may be in the same or different geo-locations. In one embodiment, the first DNS reference information comprises at least one Internet Protocol (IP) address associated with the first target hostname. In one embodiment, the first DNS reference information is included in at least one communication message received via one or more of a broadcast communication, a multicast communication, and a unicast communication. In one embodiment, the at least one communication message is received by the one DNS proxy based, at least in part, on a geo-location of the one DNS proxy, a geo-location of the further DNS proxy, or a combination thereof, wherein the transmission may be via a designated broadcast, multicast, or unicast channel, or using a network device address (e.g., media access control (MAC)) on a shared channel.

At step 303, at least one of the DNS proxies 205 (e.g., DNS proxy/cache 205a of the UT 203a) stores the first DNS reference information at a respective storage device, wherein the first DNS reference information is based, at least in part, on a first DNS query of a further DNS proxy, other than the one DNS proxy. For example, the DNS reference information may be stored/saved in an internal memory device (e.g., cache) at a UT 203, such as the DNS proxy/cache 205a of the UT 203a. Alternatively or in addition, a DNS proxy 205 may store the DNS information at an external storage device (not shown), or at a storage device of a respective user device (e.g., UD 209a associated with UT 203a). In one embodiment, the first DNS reference information is determined by the DNS server 213 based on a first DNS query caused by a further (e.g., a first) DNS proxy 205, which is different than the one or more DNS proxies 205 of step 301. In one use case scenario, there are three UTs 203 A, B, and C, which may be at a certain geo-location (e.g., in a certain neighborhood), wherein the three UTs include DNS proxies A, B, and C, respectively. Further, the DNS proxy A submits a first query to the DNS server 213 for first DNS reference information associated with a first target hostname. Furthermore, the DNS server 213 transmits the first DNS reference information to all three UTs A, B, and C, wherein at least the DNS proxy B and/or C store the first DNS reference information at a memory storage device associated with the respective UT B or UT C. In various embodiments, a memory/cache entry may be considered to include DNS reference information and DNS response packet (e.g., Header, Question, Answer, Authority, and Additional sections) and/or other cache constructs, for example, a cache entry may be comprise a resource record or chain of resource records from the Answer section, which may be utilized to achieve opportunistic DNS optimization by making use of broadcast, multicast, or unicast delivery of DNS responses to the DNS proxies. In one embodiment, upon receiving the DNS reference information including a response code indicating “No Error,” each DNS proxy 205 may store the DNS reference information in its cache, overwriting or otherwise obsoleting any previously cached entry for the same target hostname. In one embodiment, if a response timer indicates a pending resolution of a DNS request for that target hostname, then the DNS proxy 205 may forward the DNS reference information to the requesting DNS client and clear the response timer.

At step 305, the DNS proxy 205a receives a DNS request for DNS reference information associated with at least a second target hostname, wherein the DNS request is received from at least one DNS client associated with the DNS proxy 205a. For example, the DNS proxy receives the DNS request from a DNS client (e.g., DNS client 211a of the UD 209a) associated with the UT 203a. Alternatively, for example, the DNS proxy 205a may receive the DNS request from the DNS client 207a (of the UT 203a).

At step 307, in response to the DNS request for DNS reference information associated with at least a second target hostname, the DNS proxy 205a forwards, to the at least one DNS client, the stored first DNS reference information associated with the first target hostname if the second target hostname relates to the first target hostname. For example, the DNS proxy 205a forwards the stored first DNS information to the DNS client 211a, of the UD 209a associated with the UT 203a. In one embodiment, the DNS proxy 205 compares and determines if the second target hostname relates to the first target hostname (e.g., the stored information), if it is, then the DNS proxy 205 (e.g., of the second UT 203) forwards, to the at least one DNS client, the stored first DNS reference information associated with the first target hostname. For example, one or more portions of the first DNS reference information may include one or more information items that relate to the second target hostname. In one example, if the first target hostname is determined to be related to the second target hostname, then the DNS proxy 205 forwards and/or causes forwarding of the first DNS reference information to the DNS client requesting the information. In one embodiment, the first DNS reference information comprises at least one IP address, at least one IP address type, at least one classification, a geo-location associated with the one DNS proxy, a geo-location associated with the further DNS proxy, at least one communication grouping, or a combination thereof.

According to a further embodiment, if the DNS proxy 205 finds and responds using a cached entry for the requested DNS reference information, the DNS proxy 205 may nevertheless send the DNS request to the DNS server 213 to request the DNS reference information for possible cache updating. The update process may accommodate domain owners that move their services to a different host as well as it may provide some protection from an erroneous domain name resolution response that might otherwise interfere with proper domain access by many users (e.g., located in a same service coverage area). The decision to send an update domain name request to the wireless gateway 209 for a client request served from cache may be a matter of policy, for example, considering the age of the cached entry, the TTL recorded within the DNS reference information contained within a cache entry, current network or terminal loading, or other parameters. In event the first DNS proxy 205 does send an update DNS request to the DNS server, it may do so without setting a response timer recording that DNS request as pending resolution, so as to preclude subsequently sending a redundant DNS response to the DNS client after the update DNS response is received. In one embodiment, if the DNS reference information includes a response code indicating any status other than “No Error,” the DNS proxy 205 determines if there is a response timer running, indicating a pending DNS request for that target hostname, and if so, the DNS proxy 205 forwards the DNS reference information to the requesting DNS client and clears the response timer.

Accordingly, at step 309, in further response to the DNS request for DNS reference information associated with at least a second target hostname, the DNS proxy 205a transmits a second DNS query for DNS reference information. Then, at step 311, the DNS proxy 205a receives, in response to the second DNS query, second DNS reference information associated with at least the first target hostname and/or the second target hostname. For example, the DNS proxy receives from the DNS server 213 one or more information items associated with the second target hostname, which may be related to the first target hostname. For example, the DNS server 213 has access to one or more already resolved information items associated with a first target hostname which may also be associated with a second target hostname.

At step 313, the DNS proxy 205a updates the first DNS reference information stored at the storage device based, at least in part, on one or more of the second DNS reference information, a retention timer, an age of the first DNS reference information, a time period since a last forwarding of the first DNS reference information to the at least one DNS client, and a retention weighting value. For example, one or more policies defined by a user and/or a service provider may take into account a retention weighting value provided within the response from the DNS server 213 and/or otherwise configured within a UT 203, such that designated target hostnames may be retained in the storage device, for example, to preserve domain name entries upon which enterprise service level agreements depend, or domain names of a service provider.

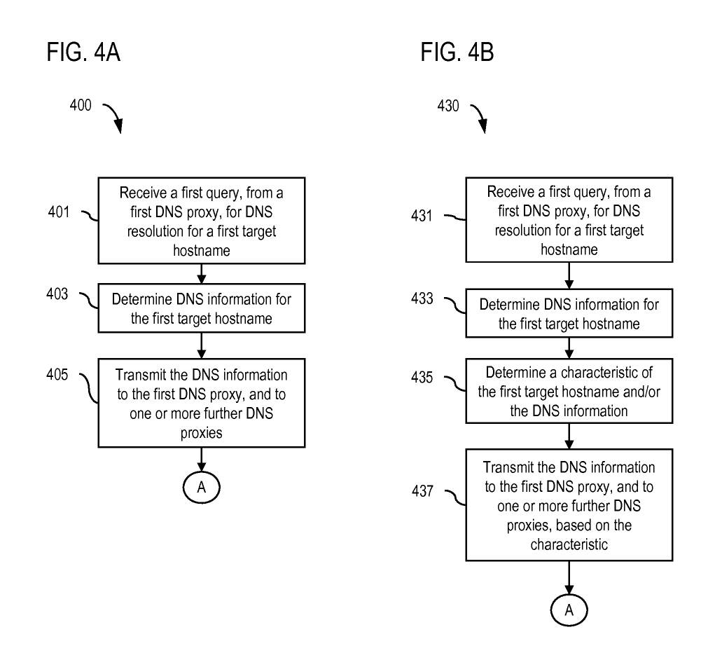

FIGS. 4A and 4B depict flow charts illustrating various processes for, at least, determining domain name resolution and characteristics information, in accordance with various exemplary embodiments.

Referring to FIG. 4A, process 400 begins at step 401, where a DNS server 213 receives a first DNS query for resolving a first target hostname, wherein the first DNS query is received from a first DNS proxy. In one example, there are a plurality of DNS proxies 205 at one or more geo-locations where the proxies are associated with a plurality of UTs 203 and/or UDs 209, wherein there is a first DNS proxy and one or more other DNS proxies. In one embodiment, DNS server receives from the first DNS proxy a first DNS query for DNS reference information associated with one or more target hostnames, for example, a request for IP address and other DNS information associated with a web page.

At step 403, DNS server 213 determines first DNS reference information associated with the first target hostname. In one embodiment, the DNS server may determine one or more DNS reference information items (e.g., IP address, geo-location, etc.) associated with the first target hostname, wherein the first target hostname may include (e.g., embedded therein) one or more other target hostnames, where the DNS sever may also determine the DNS reference information associated with the other target hostnames. For example, an initial target hostname may include therein one or more links associated with one or more other target hostnames. In one embodiment, the first DNS reference information comprises at least one IP address associated with the first target hostname.

At step 405, the DNS server 213 transmits, in response to the first DNS query, the first DNS reference information to the first DNS proxy and to one or more further DNS proxies (even though the further DNS proxies may not have requested the first DNS reference information). In one embodiment, the first DNS reference information is included in at least one communication message transmitted via one or more of a broadcast communication, a multicast communication, and a unicast communication, wherein the transmission may be via a designated broadcast, multicast, or unicast channel, or using a network device address (e.g., media access control (MAC)) on a shared channel. In one embodiment, DNS server 213 and/or the GW 138 may apply a rate limiter for DNS reference information broadcast or multicast so that the traffic throughput capacity of the UTs 203 is not substantially degraded by an excessive rate of DNS response caching. In one embodiment, GW and/or the DNS server may keep track of the rate of DNS response broadcast or multicast delivery, and may send the responses using a point-to-point (e.g., unicast) delivery format while a rate limit has been reached.

Referring to FIG. 4B, process 430 begins at step 431, where steps 431 and 433 are similar to steps of 401 and 403, respectively, of the process 400 in FIG. 4A. Further, at step 435, the DNS server 213 determines at least one characteristic associated with the first target hostname or the first DNS reference information, or a combination thereof. In one embodiment, the at least one characteristic comprises at least one IP address, at least one IP address type, at least one classification, a geo-location associated with the first DNS proxy, a geo-location associated with at least one of the further DNS proxies, at least one communication grouping, or a combination thereof. Furthermore, at step 437, the first DNS reference information is transmitted to the first DNS proxy, and to one or more further DNS proxies (even though the further DNS proxies may not have requested the first DNS reference information), based at least in part on the at least one characteristic. For example, the first and the one or more further DNS proxies are located close to a certain geo-location and the first DNS reference information is transmitted to them based on their geo-location. In one example, the transmission is based on an IP address type of “AAAA” associated with the first target hostname.

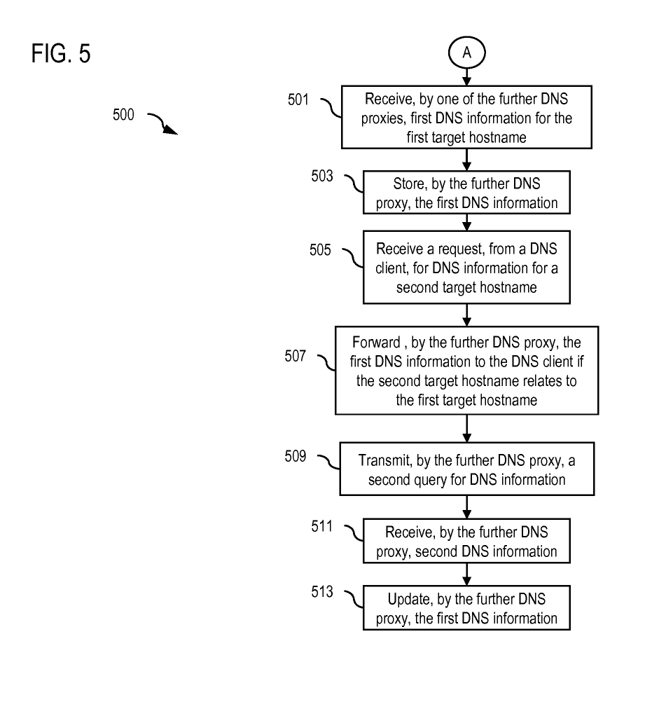

FIG. 5 depicts a flow chart illustrating an optimized domain name resolution and delivery process, in accordance with various exemplary embodiments. For example, from steps 405 and 437, respectively, the one or more further DNS proxies receive the DNS reference information transmitted in response to the first query of the first DNS proxy.

The process begins at step 501, where a one of the further DNS proxies receives the first DNS reference information associated with the first target hostname. In one example, there are a plurality of DNS proxies 205, at one or more geo-locations where the proxies are associated with a plurality of UTs 203 and/or UDs 209, wherein there is a first DNS proxy and one or more other/further DNS proxies. In one embodiment, one or more of the other/further DNS proxies receive one or more DNS reference information items associated with a first target hostname. For example, the DNS server 213 transmits the first DNS reference information associated with the first target hostname to one or more of the further DNS proxies. For example, the further DNS proxy 205b receives the first DNS reference information, which was transmitted (e.g. via a broadcast or multicast communication) in response to a first DNS query of the first DNS proxy (e.g., DNS proxy 205a).

At step 503, the further DNS proxy 205b stores the first DNS reference information at a respective storage device. As described above, for example, the DNS reference information may be stored/saved in an internal memory device (e.g., cache) at a UT 203, such as the DNS proxy/cache 205b of the UT 203b. Alternatively or in addition, a DNS proxy 205b may store the DNS information at an external storage device (not shown), or at a storage device of a respective user device (e.g., UD 209b associated with UT 203b).

At step 505, the further DNS proxy 205b receives a DNS request for DNS reference information associated with at least a second target hostname, wherein the DNS request is received from at least one DNS client associated with the one further DNS proxy (e.g., either DNS client 207b or 211b). In one embodiment, one or more further DNS proxies may receive one or more DNS requests from one or more DNS clients that are associated with one or more UTs 203 and/or one or more UDs 209. For example, a DNS client in a UD may request DNS reference information associated with a second target hostname. In one embodiment, a UD 209 may cause a DNS client in a UT 203 to cause a DNS request for the DNS reference information associated with the second target hostname.

At step 507, in response to the DNS request for DNS reference information associated with at least a second target hostname, the further DNS proxy 205b forwards, to the at least one DNS client (e.g., either DNS client 207b or 211b), the stored first DNS reference information associated with the first target hostname if the second target hostname relates to the first target hostname. In one embodiment, the further DNS proxy 205b compares and determines if the second target hostname relates to the first target hostname, if it is, then the DNS proxy 205 forwards, to the at least one DNS client, the stored first DNS reference information associated with the first target hostname. In one embodiment, the further DNS proxy may compare the second target hostname to the first target hostname, for example already in a storage device, to determine if the first and the second target hostnames are related (e.g., same, have one or more common elements, etc.)

At step 509, in further response to the DNS request for DNS reference information associated with at least a second target hostname, the further DNS proxy 205b transmits a second DNS query for DNS reference information. Then, at step 511, the DNS proxy 205b receives, in response to the second DNS query, second DNS reference information associated with at least the first target hostname and/or the second target hostname. For example, the DNS proxy receives from the DNS server 213 one or more information items associated with the second target hostname, which may be related to the first target hostname. For example, the DNS server 213 has access to one or more already resolved information items associated with a first target hostname which may also be associated with a second target hostname.

At step 513, the DNS proxy 205b updates the first DNS reference information stored at the storage device based, at least in part, on one or more of the second DNS reference information, a retention timer, an age of the first DNS reference information, a time period since a last forwarding of the first DNS reference information to the at least one DNS client, and a retention weighting value. For example, one or more policies defined by a user and/or a service provider may take into account a retention weighting value provided within the response from the DNS server 213 and/or otherwise configured within a UT 203, such that designated target hostnames may be retained in the storage device, for example, to preserve domain name entries upon which enterprise service level agreements depend, or domain names of a service provider.

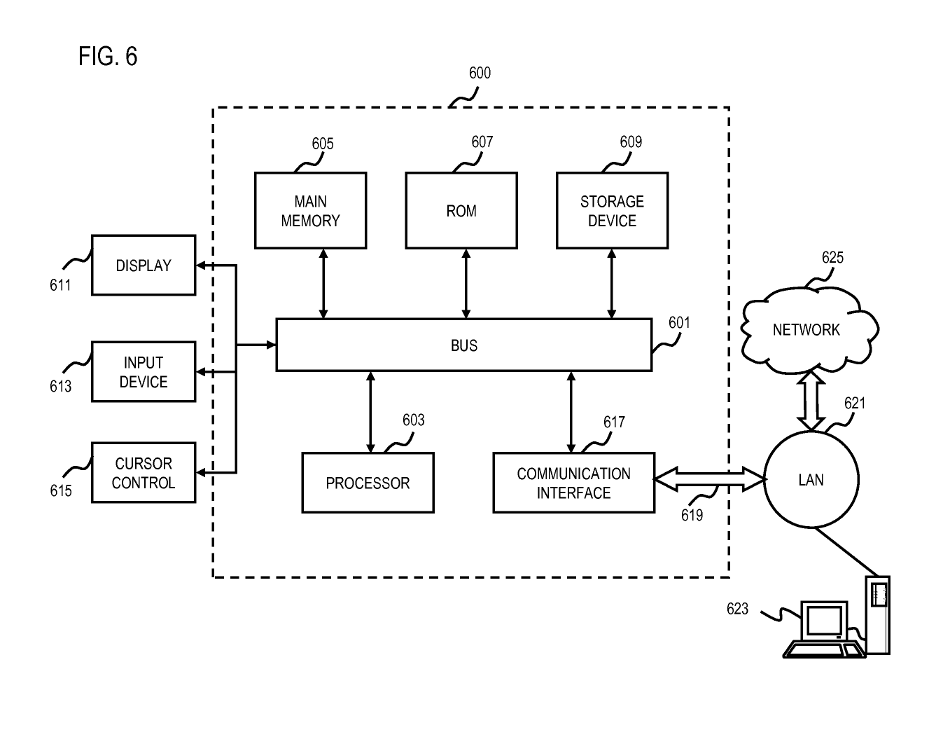

FIG. 6 illustrates a computer system upon which exemplary embodiments according to the present invention can be implemented. The computer system 600 includes a bus 601 or other communication mechanism for communicating information, and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions to be executed by the processor 603. The computer system 600 further includes a read only memory (ROM) 607 or other static storage device coupled to the bus 601 for storing static information and instructions for the processor 603. A storage device 609, such as a magnetic disk or optical disk, is additionally coupled to the bus 601 for storing information and instructions.

The computer system 600 is coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is cursor control 615, such as a mouse, a trackball, or cursor direction keys for communicating direction information and command selections to the processor 603 and for controlling cursor movement on the display 611.

According to one embodiment of the invention, optimized domain name resolution and delivery system, in accordance with exemplary embodiments, are provided by the computer system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry is used in place of or in combination with software instructions to implement the embodiment of the present invention. Thus, embodiments of the present invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, or a telephone modem to provide a data communication connection to a corresponding type of telephone line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617, for example, includes peripheral interface devices, such as a Universal Serial Bus (USB) interface, a PCMCIA (Personal Computer Memory Card International Association) interface, etc.

The network link 619 typically provides data communication through one or more networks to other data devices. For example, the network link 619 provides a connection through local network 621 to a host computer 623, which has connectivity to a network 625 (e.g. a wide area network (WAN) or the global packet data communication network now commonly referred to as the “Internet”) or to data equipment operated by service provider. The local network 621 and network 625 both use electrical, electromagnetic, or optical signals to convey information and instructions. The signals through the various networks and the signals on network link 619 and through communication interface 617, which communicate digital data with computer system 600, are exemplary forms of carrier waves bearing the information and instructions.

The computer system 600 sends messages and receives data, including program code, through the network(s), network link 619, and communication interface 617. In the Internet example, a server (not shown) might transmit requested code belonging to an application program for implementing an embodiment of the present invention through the network 625, local network 621 and communication interface 617. The processor 603 executes the transmitted code while being received and/or store the code in storage device 239, or other non-volatile storage for later execution. In this manner, computer system 600 obtains application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as storage device 609. Volatile media may include dynamic memory, such as main memory 605. Transmission media may include coaxial cables, copper wire and fiber optics, including the wires that comprise bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD ROM, CDRW, DVD, any other optical medium, punch cards, paper tape, optical mark sheets, any other physical medium with patterns of holes or other optically recognizable indicia, a RAM, a PROM, and EPROM, a FLASH EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

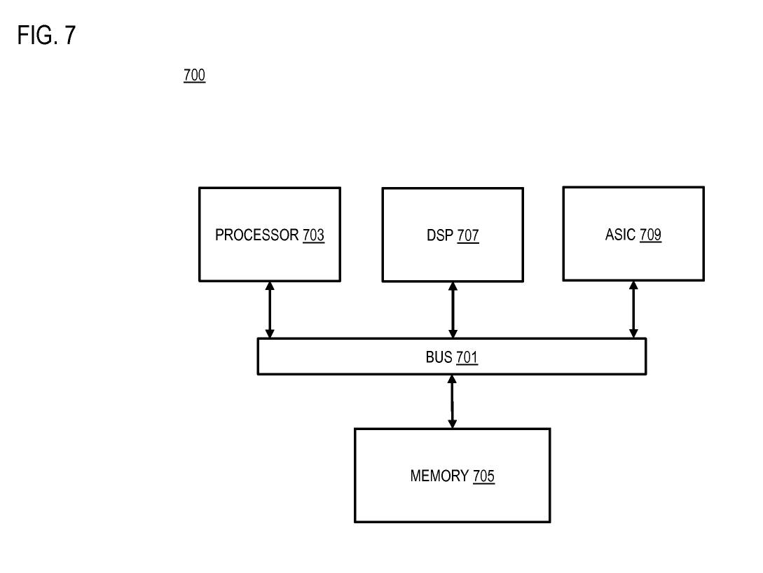

FIG. 7 illustrates a chip set 700 in which exemplary embodiments of the present invention may be implemented. Chip set 700 includes, for instance, processor and memory components described with respect to FIG. 7 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 includes one or more processing cores with each core configured to perform independently. A multi-core processor enables multiprocessing within a single physical package. Examples of a multi-core processor include two, four, eight, or greater numbers of processing cores. Alternatively or in addition, the processor 703 includes one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, and/or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM) and static memory (e.g., ROM) for storing executable instructions that, when executed by the processor 703 and/or the DSP 707 and/or the ASIC 709, perform the process of exemplary embodiments as described herein. The memory 705 also stores the data associated with or generated by the execution of the process.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by one or more Domain Name System (DNS) proxies, first DNS reference information associated with at least a first target hostname; and
storing, by a one of the DNS proxies, the first DNS reference information at a respective storage device, wherein the first DNS reference information is based at least in part on a first DNS query of a further DNS proxy, other than the one DNS proxy.

2. The method of claim 1, further comprising:
receiving, by the one DNS proxy, a DNS request for DNS reference information associated with at least a second target hostname, wherein the DNS request is received from at least one DNS client associated with the one DNS proxy; and
forwarding, to the at least one DNS client, the stored first DNS reference information associated with the first target hostname if the second target hostname relates to the first target hostname.

3. The method of claim 2, wherein the first DNS reference information comprises at least one Internet Protocol (IP) address, at least one IP address type, at least one classification, a geo-location associated with the one DNS proxy, a geo-location associated with the further DNS proxy, at least one communication grouping, or a combination thereof.

4. The method of claim 1, wherein the first DNS reference information comprises at least one Internet Protocol (IP) address associated with the first target hostname.

5. The method of claim 1, wherein the first DNS reference information is included in at least one communication message received via one or more of a broadcast communication, a multicast communication, and a unicast communication.

6. The method of claim 5, wherein the at least one communication message is received by the one DNS proxy based at least in part on a geo-location of the one DNS proxy, a geo-location of the further DNS proxy, or a combination thereof.

7. The method of claim 2, further comprising:
transmitting, by the one DNS proxy, a second DNS query for DNS reference information;
receiving, in response to the second DNS query, second DNS reference information associated with at least the first target hostname; and
updating the first DNS reference information stored at the storage device based at least in part on one or more of the second DNS reference information, a retention timer, an age of the first DNS reference information, a time period since a last forwarding of the first DNS reference information to the at least one DNS client, and a retention weighting value.

8. A method comprising:
receiving, by a Domain Name System (DNS) server, a first DNS query for resolving a first target hostname, wherein the first DNS query is received from a first DNS proxy;
determining first DNS reference information associated with the first target hostname; and
transmitting, in response to the first DNS query, the first DNS reference information to the first DNS proxy and to one or more further DNS proxies.

9. The method of claim 8, wherein the first DNS reference information is included in at least one communication message transmitted via one or more of a broadcast communication, a multicast communication, and a unicast communication.

10. The method of claim 8, further comprising:
determining at least one characteristic associated with the first target hostname or the first DNS reference information, or a combination thereof,
wherein the transmission of the first DNS reference information is based at least in part on the at least one characteristic.

11. The method of claim 10, wherein the at least one characteristic comprises at least one Internet Protocol (IP) address, at least one IP address type, at least one classification, a geo-location associated with the first DNS proxy, a geo-location associated with at least one of the further DNS proxies, at least one communication grouping, or a combination thereof.

12. The method of claim 8, wherein the first DNS reference information comprises at least one IP address associated with the first target hostname.

13. The method of claim 8, further comprising:
receiving, by a one of the further DNS proxies, the first DNS reference information associated with the first target hostname; and
storing, by the one further DNS proxy, the first DNS reference information at a respective storage device.

14. The method of claim 13, further comprising:
receiving, by the one further DNS proxy, a DNS request for DNS reference information associated with at least a second target hostname, wherein the DNS request is received from at least one DNS client associated with the one further DNS proxy; and
forwarding, to the at least one DNS client, the stored first DNS reference information associated with the first target hostname if the second target hostname relates to the first target hostname.

15. The method of claim 14, further comprising:
transmitting, by the further DNS proxy, a second DNS query for DNS reference information;
receiving, in response to the second DNS query, second DNS reference information associated with at least the first target hostname; and
updating the first DNS reference information stored at the storage device based at least in part on one or more of the second DNS reference information, a retention timer, an age of the first DNS reference information, a time period since a last forwarding of the first DNS reference information to the at least one DNS client, and a retention weighting value.

16. An apparatus comprising:
at least one processor; and
at least one memory including computer program code for one or more programs,
the at least one memory and the computer program code configured to, with the at least one processor, cause the apparatus to perform at least the following,
receive first DNS reference information associated with at least a first target hostname; and
store the first DNS reference information at a respective storage device, wherein the first DNS reference information is based at least in part on a first DNS query, wherein the first DNS query is a query of one or more DNS proxies not associated with the apparatus.

17. The apparatus of claim 16, wherein the apparatus is further caused to:
receive a DNS request for DNS reference information associated with at least a second target hostname, wherein the DNS request is received from at least one DNS client associated with the apparatus; and
forward, to the at least one DNS client, the stored first DNS reference information associated with the first target hostname if the second target hostname relates to the first target hostname.

18. The apparatus of claim 17, wherein the first DNS reference information comprises at least one Internet Protocol (IP) address, at least one IP address type, at least one classification, a geo-location associated with the apparatus, a geo-location associated with the at least one of the DNS proxies not associated with the apparatus, at least one communication grouping, or a combination thereof.

19. The apparatus of claim 16, wherein the first DNS reference information comprises at least one Internet Protocol (IP) address associated with the first target hostname.

20. The apparatus of claim 16, wherein the first DNS reference information is included in at least one communication message received via one or more of a broadcast communication, a multicast communication, and a unicast communication.

21. The apparatus of claim 20, wherein the at least one communication message is received by the apparatus based at least in part on a geo-location of the apparatus, a geo-location of at least one of the DNS proxies not associated with the apparatus, or a combination thereof.

22. The apparatus of claim 17, wherein the apparatus is further caused to:
transmit a second DNS query for DNS reference information;
receive, in response to the second DNS query, second DNS reference information associated with at least the first target hostname; and
update the first DNS reference information stored at the storage device based at least in part on one or more of the second DNS reference information, a retention timer, an age of the first DNS reference information, a time period since a last forwarding of the first DNS reference information to the at least one DNS client, and a retention weighting value.

23. An apparatus comprising:
at least one processor; and
at least one memory including computer program code for one or more programs,
the at least one memory and the computer program code configured to, with the at least one processor, cause the apparatus to perform at least the following,
receive a first DNS query for resolving a first target hostname, wherein the first DNS query is received from a first DNS proxy;
determine first DNS reference information associated with the first target hostname; and
transmit, in response to the first DNS query, the first DNS reference information to the first DNS proxy and to one or more further DNS proxies.

24. The apparatus of claim 23, wherein the first DNS reference information is included in at least one communication message transmitted via one or more of a broadcast communication, a multicast communication, and a unicast communication.

25. The apparatus of claim 23, wherein the apparatus is further caused to:
determine at least one characteristic associated with the first target hostname or the first DNS reference information, or a combination thereof,
wherein the transmission of the first DNS reference information is based at least in part on the at least one characteristic.

26. The apparatus of claim 25, wherein the at least one characteristic comprises at least one Internet Protocol (IP) address, at least one IP address type, at least one classification, a geo-location associated with the first DNS proxy, a geo-location associated with at least one of the further DNS proxies, at least one communication grouping, or a combination thereof.

27. The apparatus of claim 23, wherein the first DNS reference information comprises at least one IP address associated with the first target hostname.

28. The apparatus of claim 23, wherein the apparatus is further caused to:
receive the first DNS reference information associated with the first target hostname; and
store the first DNS reference information at a respective storage device.

29. The apparatus of claim 28, wherein the apparatus is further caused to:
receive a DNS request for DNS reference information associated with at least a second target hostname, wherein the DNS request is received from at least one DNS client associated with the apparatus; and
forward, to the at least one DNS client, the stored first DNS reference information associated with the first target hostname if the second target hostname relates to the first target hostname.

30. The apparatus of claim 29, wherein the apparatus is further caused to:
transmit a second DNS query for DNS reference information;
receive, in response to the second DNS query, second DNS reference information associated with at least the first target hostname; and
update the first DNS reference information stored at the storage device based at least in part on one or more of the second DNS reference information, a retention timer, an age of the first DNS reference information, a time period since a last forwarding of the first DNS reference information to the at least one DNS client, and a retention weighting value.

31. A system, comprising:
a first Domain Name System (DNS) proxy module configured to generate a first DNS query for resolving a first target hostname; and
a DNS server, wherein the DNS server is configured to receive the first DNS query from the first DNS proxy, to determine first DNS reference information associated with the first target hostname, and to transmit the first DNS reference information for receipt by the first DNS proxy module and by one or more further DNS proxy modules, wherein the first DNS reference information is transmitted via at least one communication message transmitted via one or more of a broadcast communication, a multicast communication, and a unicast communication.

32. The system of claim 31, further comprising:
one or more further DNS proxy modules, wherein at least one of the further DNS proxy modules is configured to receive the first DNS reference information, and to store the first DNS reference information at a respective storage device.

33. The system of claim 31, wherein the at least one further DNS proxy module is further configured to:
receive a DNS request for DNS reference information associated with at least a second target hostname, wherein the DNS request is received from at least one DNS client associated with the at least one further DNS proxy module; and
forward, to the at least one DNS client, the stored first DNS reference information associated with the first target hostname if the second target hostname relates to the first target hostname.

34. The system of claim 31, wherein the at least one further DNS proxy module is configured to:
transmit a second DNS query for DNS reference information;
receive, in response to the second DNS query, second DNS reference information associated with at least the first target hostname; and update the first DNS reference information stored at the storage device based at least in part on one or more of the second DNS reference information, a retention timer, an age of the first DNS reference information, a time period since a last forwarding of the first DNS reference information to the at least one DNS client, and a retention weighting value.
